(19) United States
(12) Patent Application Publication
(10) Pub. No.: US 2022/0163753 A1
(43) Pub. Date: May 26, 2022

(54) LENS DRIVING DEVICE

(71) Applicant: Murata Manufacturing Co., Ltd., Nagaokakyo-shi (JP)

(72) Inventor: Takuya SUGIMOTO, Nagaokakyo-shi (JP)

(21) Appl. No.: 17/670,550

(22) Filed: Feb. 14, 2022

Related U.S. Application Data
(63) Continuation of application No. PCT/JP2020/029225, filed on Jul. 30, 2020.

(30) Foreign Application Priority Data
Sep. 2, 2019 (JP) 2019-159449

(51) Int. Cl. G02B 7/08; G02B 7/02

(52) U.S. Cl. CPC G02B 7/08; H02K 41/0356; G02B 7/021

(57) ABSTRACT

A lens driving device includes a first magnetic sensor to detect a magnetic field applied from a first position detecting magnet that moves relatively when a lens holder moves in an optical axis direction. When viewed from the optical axis direction, a center of the first magnetic sensor and a center of the first position detecting magnet are displaced from each other in a circumferential direction of an optical axis.

### CROSS REFERENCE TO RELATED APPLICATIONS

This application claims the benefit of priority to Japanese Patent Application No. 2019-159449 filed on Sep. 2, 2019 and is a Continuation Application of PCT Application No. PCT/JP2020/029225 filed on Jul. 30, 2020. The entire contents of each application are hereby incorporated herein by reference.

### BACKGROUND OF THE INVENTION

### 1. Field of the Invention

The present invention relates to a lens driving device.

### 2. Description of the Related Art

US 2019/0020822 and Japanese Unexamined Patent Application Publication No. 2015-141329 are prior art documents disclosing a configuration of a lens driving device.

As a drive mechanism for providing an autofocus function, a lens driving device described in US 2019/0020822 includes a voice coil motor, and a lens driving device described in Japanese Unexamined Patent Application Publication No. 2015-141329 includes a piezoelectric element. The lens driving devices described in US 2019/0020822 and Japanese Unexamined Patent Application Publication No. 2015-141329 each include a position detecting magnet and a magnetic sensor for detecting a position of a lens in an optical axis direction of the lens.

The lens driving device is required to have a large movable range of the lens in the optical axis direction of the lens. In order to increase the movable range of the lens, it is necessary to increase a range in which the position of the lens in the optical axis direction of the lens can be detected, that is, to increase a relative movement range of the magnetic sensor with respect to the position detecting magnet, in which an output having linearity is obtained from the magnetic sensor. When the size of the position detecting magnet is increased in order to increase the relative movement range described above of the magnetic sensor, the size and weight of the lens driving device are increased.

### SUMMARY OF THE INVENTION

Preferred embodiments of the present invention provide lens driving devices that are each able to increase a movable range of a lens without increasing a size of a position detecting magnet.

A lens driving device according to a preferred embodiment of the present invention includes a lens holder, a driver, a first position detecting magnet, and a first magnetic sensor. The lens holder includes a cavity and holds a lens. The driver moves the lens holder in an optical axis direction of the lens passing through a center of the cavity. The first magnetic sensor is capable of detecting a magnetic field applied from the first position detecting magnet that moves relatively when the lens holder moves in the optical axis direction of the lens. One of the first position detecting magnet and the first magnetic sensor is located on an outer peripheral side of the lens holder. Another one of the first position detecting magnet and the first magnetic sensor is located at a distance from the one of the first position detecting magnet and the first magnetic sensor in a radial direction of the optical axis of the lens. When viewed from an optical axis direction of the lens, a center or approximate center of the first magnetic sensor and a center or approximate center of the first position detecting magnet are displaced from each other in a circumferential direction of the optical axis.

According to preferred embodiments of the present invention, it is possible to increase the movable range of the lens without increasing the size of the position detecting magnet in the lens driving devices.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating a configuration of a lens driving device according to Preferred Embodiment 1 of the present invention.

FIG. 2 is an exploded perspective view illustrating the configuration of the lens driving device according to Preferred Embodiment 1 of the present invention.

FIG. 3 is a perspective view illustrating a positional relationship between a first position detecting magnet and a first magnetic sensor in the lens driving device according to Preferred Embodiment 1 of the present invention.

FIG. 4 is a partially enlarged view of the first position detecting magnet and the first magnetic sensor illustrated in FIG. 3 as viewed from the direction of an arrow IV.

FIG. 5 is a diagram of the first position detecting magnet and the first magnetic sensor of FIG. 4 as viewed from the direction of an arrow V.

FIG. 6 is a graph illustrating a relationship between a phase of a rotating magnetic field applied from the first position detecting magnet to the first magnetic sensor and an output of the first magnetic sensor in the lens driving device according to Preferred Embodiment 1 of the present invention.

FIG. 7 is a diagram illustrating a configuration of the first magnetic sensor of the lens driving device according to Preferred Embodiment 1 of the present invention.

FIG. 8 is a diagram illustrating a circuit configuration of the first magnetic sensor of the lens driving device according to Preferred Embodiment 1 of the present invention.

FIG. 9 is an enlarged perspective view illustrating a portion IX of FIG. 7.

FIG. 10 is a cross-sectional view taken along a line X-X of FIG. 9.

FIG. 11 is a diagram illustrating a magnetization direction of a first position detecting magnet in a lens driving device according to Comparative Example.

FIG. 12 is a diagram illustrating a positional relationship between a first position detecting magnet and a first magnetic sensor, a magnetic field applied from the first position detecting magnet to the first magnetic sensor, and a relative movement range of the first magnetic sensor with respect to the first position detecting magnet in an optical axis direction of a lens, in which an output having linearity is obtained from the first magnetic sensor, in the lens driving device according to Comparative Example.

FIG. 13 is a graph illustrating a relationship between a relative movement range of a first magnetic sensor with respect to a first position detecting magnet in an optical axis direction of a lens and a linearity error rate of an output of the first magnetic sensor in the lens driving device according to Comparative Example.

FIG. 14 is a diagram illustrating a magnetization direction of a first position detecting magnet in a lens driving device according to Example 1 of a preferred embodiment of the present invention.

FIG. 15 is a diagram illustrating a positional relationship between a first position detecting magnet and a first magnetic sensor, a magnetic field applied from the first position detecting magnet to the first magnetic sensor, and a relative movement range of the first magnetic sensor with respect to the first position detecting magnet in an optical axis direction of a lens, in which an output having linearity is obtained from the first magnetic sensor, in the lens driving device according to Example 1.

FIG. 16 is a graph illustrating a relationship between a relative movement range of a first magnetic sensor with respect to a first position detecting magnet in an optical axis direction of a lens and a linearity error rate of an output of the first magnetic sensor in the lens driving device according to Example 1.

FIG. 17 is a diagram illustrating a magnetization direction of a first position detecting magnet in a lens driving device according to Example 2 of a preferred embodiment of the present invention.

FIG. 18 is a diagram illustrating a positional relationship between a first position detecting magnet and a first magnetic sensor, a magnetic field applied from the first position detecting magnet to the first magnetic sensor, and a relative movement range of the first magnetic sensor with respect to the first position detecting magnet in an optical axis direction of a lens, in which an output having linearity is obtained from the first magnetic sensor, in the lens driving device according to Example 2.

FIG. 19 is a diagram illustrating a positional relationship between a first position detecting magnet and a first magnetic sensor, a magnetic field applied from the first position detecting magnet to the first magnetic sensor, and a relative movement range of the first magnetic sensor with respect to the first position detecting magnet in an optical axis direction of a lens, in which an output having linearity is obtained from the first magnetic sensor, in a lens driving device according to Example 3 of a preferred embodiment of the present invention.

FIG. 20 is a perspective view illustrating a positional relationship among a first position detecting magnet, a first magnetic sensor, a second position detecting magnet, and a second magnetic sensor in a lens driving device according to Preferred Embodiment 2 of the present invention.

FIG. 21 is a diagram illustrating a circuit configuration of the first magnetic sensor and the second magnetic sensor of the lens driving device according to Preferred Embodiment 2 of the present invention.

FIG. 22 is a perspective view illustrating a positional relationship among a first position detecting magnet, a first magnetic sensor, a second position detecting magnet, and a second magnetic sensor in a lens driving device according to Preferred Embodiment 3 of the present invention.

### DETAILED DESCRIPTION OF THE PREFERRED EMBODIMENTS

Hereinafter, lens driving devices according to preferred embodiments of the present invention will be described with reference to the drawings. In the following description of the preferred embodiments, the same or corresponding portions in the drawings are denoted by the same reference numerals, and description thereof will not be repeated.

### Preferred Embodiment 1

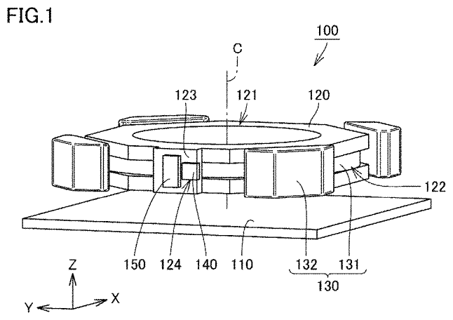

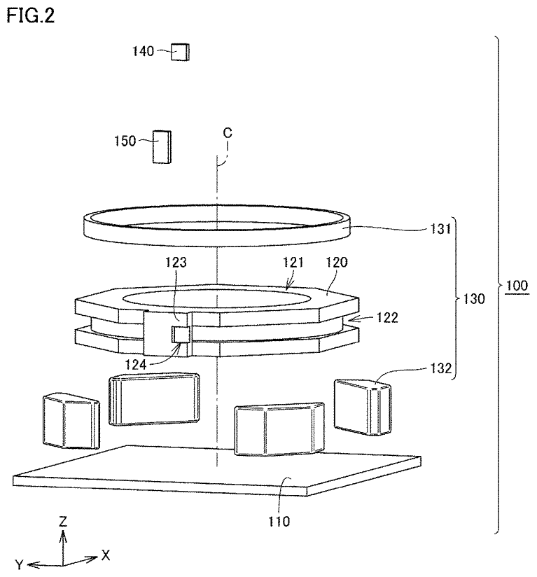

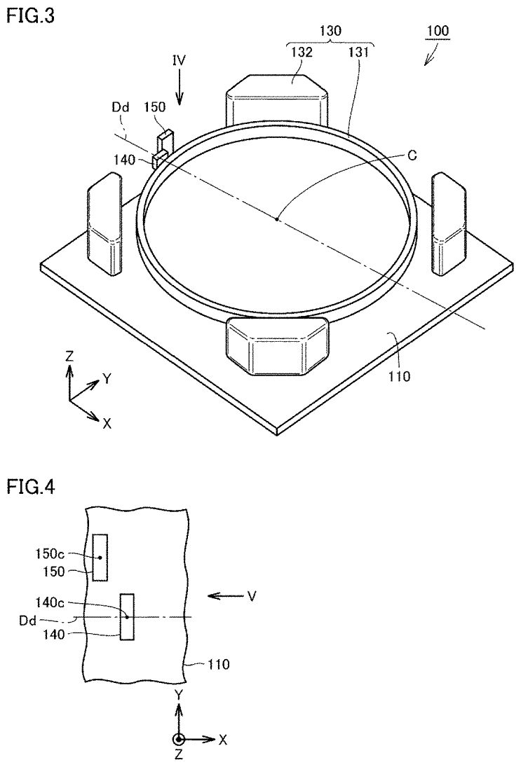

FIG. 1 is a perspective view illustrating a configuration of a lens driving device according to Preferred Embodiment 1 of the present invention. FIG. 2 is an exploded perspective view illustrating the configuration of the lens driving device according to Preferred Embodiment 1 of the present invention. FIG. 3 is a perspective view illustrating a positional relationship between a first position detecting magnet and a first magnetic sensor in the lens driving device according to Preferred Embodiment 1 of the present invention. FIG. 4 is a partially enlarged view of the first position detecting magnet and the first magnetic sensor illustrated in FIG. 3 as viewed from the direction of an arrow IV. FIG. 5 is a diagram of the first position detecting magnet and the first magnetic sensor illustrated in FIG. 4 as viewed from the direction of an arrow V. In FIG. 3 to FIG. 5, a lens holder is not illustrated.

In FIG. 1 to FIG. 5, a direction parallel or substantially parallel to an optical axis direction of a lens described later is illustrated as a Z-axis direction, a direction parallel or substantially parallel to a radial direction of an optical axis passing through a center of a first position detecting magnet described later is illustrated as an X-axis direction, and a direction orthogonal or substantially orthogonal to each of the X-axis direction and the Z-axis direction is illustrated as a Y-axis direction. Note that the radial direction of the optical axis is a radial direction of a virtual circle centered on the optical axis.

As illustrated in FIG. 1 and FIG. 2, a lens driving device 100 according to Preferred Embodiment 1 of the present invention includes a substrate 110, a lens holder 120, a driver 130, a first position detecting magnet 140, and a first magnetic sensor 150. Each of the lens holder 120, the driver 130, the first position detecting magnet 140, and the first magnetic sensor 150 is mounted on the substrate 110 with a connection structure (not illustrated) interposed therebetween.

The lens holder 120 includes a circular or substantially circular cavity 121 which allows light to pass therethrough to the lens, and holds the lens. The lens holder 120 has a cylindrical or substantially cylindrical shape. The lens holder 120 has an octagonal or substantially octagonal shape centered on an optical axis C of the lens passing through the center of the cavity 121 when viewed from the Z-axis direction. An outer peripheral surface of the lens holder 120 is continuous with each side of an octagon or a substantial octagon seen from the Z-axis direction, and extends along the Z-axis direction. In this manner, the lens holder 120 includes eight outer peripheral surfaces. An annular groove 122 centered on the optical axis C when viewed from the Z-axis direction is provided on the outer peripheral surface of the lens holder 120.

An attachment portion 123 is provided on an outer peripheral surface continuous with one side of the above-described octagon or substantial octagon when the lens holder 120 is viewed from the Z-axis direction. The attachment portion 123 covers a portion of the groove 122. A rectangular or substantially rectangular recessed portion 124 is provided on an outer surface of the attachment portion 123 opposite to an inner surface facing the groove 122. Note that the shape of the lens holder 120 is not limited to the above-described shape, and any shape may be used as long as it includes the cavity 121 inside which the lens is provided.

The driver 130 moves the lens holder 120 in the optical axis direction of the lens, which is a direction parallel or substantially parallel to the optical axis C of the lens passing through the center of the cavity 121. In Preferred Embodiment 1 of the present invention, the driver 130 includes a drive coil 131 and a drive magnet 132. The driver 130 is, for example, a voice coil motor.

The drive coil 131 is wound around the lens holder 120. Specifically, the drive coil 131 is wound around the bottom surface of the groove 122 of the lens holder 120.

The drive magnet 132 faces an outer peripheral side of the drive coil 131 with a gap therebetween. In Preferred Embodiment 1 of the present invention, four drive magnets 132 face the outer peripheral surface of lens holder 120.

Specifically, in the eight outer peripheral surfaces of the lens holder 120 in a circumferential direction of the optical axis C, a surface facing the drive magnet 132 and a surface not facing the drive magnet 132 are alternately arranged in the circumferential direction of the optical axis C. The outer peripheral surface on which the attachment portion 123 is provided is a surface that does not face the drive magnet 132. The drive magnets 132 are provided at equal or substantially equal intervals in the circumferential direction of the optical axis C.

Note that the number of drive magnets 132 is not limited to four and may be at least one. However, in order to reduce or prevent the inclination of the lens holder 120, it is preferable that a plurality of the drive magnets 132 are provided symmetrically or substantially symmetrically with respect to the optical axis C.

The driver 130 can drive the lens holder 120 in the optical axis direction of the lens by a Lorentz force generated when a current flows through the drive coil 131. Note that the driver 130 is not limited to the voice coil motor, and may be a piezoelectric element or a shape memory alloy that expands and contracts in the optical axis direction of the lens.

As illustrated in FIG. 1, the first position detecting magnet 140 is located on the outer peripheral side of the lens holder 120. In Preferred Embodiment 1 of the present invention, the first position detecting magnet 140 has a rectangular or substantially rectangular parallelepiped shape. The first position detecting magnet 140 is fitted into the recessed portion 124 of the attachment portion 123. Therefore, the first position detecting magnet 140 moves in the optical axis direction of the lens together with the lens holder 120.

In Preferred Embodiment 1 of the present invention, a magnetization direction of the first position detecting magnet 140 is along a radial direction Dd of the optical axis C passing through a center 140c of the first position detecting magnet 140 illustrated in FIG. 4.

As illustrated in FIG. 3 and FIG. 4, the first magnetic sensor 150 is located at a distance from the first position detecting magnet 140 in the radial direction of the optical axis C of the lens. The first magnetic sensor 150 is fixed to the substrate 110.

Note that the positional relationship between the first position detecting magnet 140 and the first magnetic sensor 150 may be reversed such that the first magnetic sensor 150 is fitted into the recessed portion 124 of the attachment portion 123 of the lens holder 120, the first magnetic sensor 150 moves in the optical axis direction of the lens together with the lens holder 120, and the first position detecting magnet 140 is fixed to the substrate 110.

As illustrated in FIG. 4, a center 150c of the first magnetic sensor 150 and the center 140c of the first position detecting magnet 140 are displaced from each other in the circumferential direction of the optical axis C when viewed from the optical axis direction of the lens.

In Preferred Embodiment 1 of the present invention, the center 150c of the first magnetic sensor 150 does not overlap the first position detecting magnet 140 in the circumferential direction of the optical axis C when viewed from the optical axis direction of the lens.

However, as long as the center 150c of the first magnetic sensor 150 and the center 140c of the first position detecting magnet 140 are displaced from each other in the circumferential direction of the optical axis C when viewed from the optical axis direction of the lens, the center 150c of the first magnetic sensor 150 may overlap the first position detecting magnet 140 in the circumferential direction of the optical axis C.

Furthermore, in Preferred Embodiment 1 of the present invention, the first magnetic sensor 150 does not overlap the first position detecting magnet 140 in the circumferential direction of the optical axis C when viewed from the optical axis direction of the lens.

However, as long as the center 150c of the first magnetic sensor 150 and the center 140c of the first position detecting magnet 140 are positioned to be displaced from each other in the circumferential direction of the optical axis C when viewed from the optical axis direction of the lens, the first magnetic sensor 150 may overlap the first position detecting magnet 140 in the circumferential direction of the optical axis C.

As illustrated in FIG. 5, the first magnetic sensor 150 can detect a rotating magnetic field applied from the first position detecting magnet 140 that moves relatively when the lens holder 120 moves in the optical axis direction of the lens.

Therefore, in Preferred Embodiment 1 of the present invention, since the magnetization direction of the first position detecting magnet 140 is along the radial direction Dd of the optical axis C passing through the center 140c of the first position detecting magnet 140 illustrated in FIG. 4, when the center 150c of the first magnetic sensor 150 and the center 140c of the first position detecting magnet 140 are located at the same position in the optical axis direction of the lens as illustrated in FIG. 5, a phase θ of the rotating magnetic field applied from the first position detecting magnet 140 to the first magnetic sensor 150 becomes 0°.

When the center 150c of the first magnetic sensor 150 rises relative to the center 140c of the first position detecting magnet 140 in the optical axis direction of the lens, the phase θ of the rotating magnetic field applied from the first position detecting magnet 140 to the first magnetic sensor 150 becomes +α.

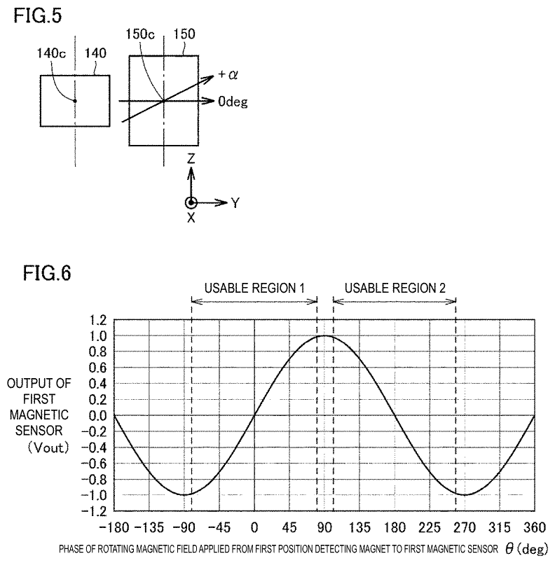

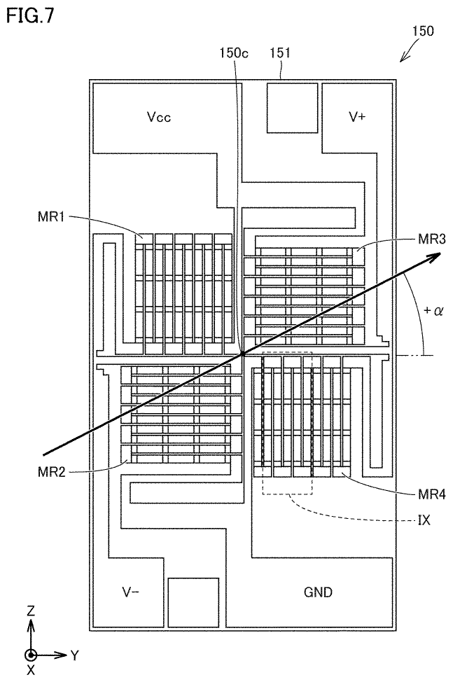

FIG. 6 is a graph illustrating the relationship between the phase of the rotating magnetic field applied from the first position detecting magnet to the first magnetic sensor and the output of the first magnetic sensor in the lens driving device according to Preferred Embodiment 1 of the present invention. In FIG. 6, the vertical axis represents an output (Vout) of the first magnetic sensor, and the horizontal axis represents the phase θ (deg) of the rotating magnetic field applied from the first position detecting magnet to the first magnetic sensor.

As illustrated in FIG. 6, the output (Vout) of the first position detecting magnet 140 and the phase θ of the rotating magnetic field applied from the first position detecting magnet 140 to the first magnetic sensor 150 satisfy the relationship of Vout=sin θ.

Since a usable region of the first magnetic sensor 150 is a range in which the output (Vout) of the first position detecting magnet 140 has linearity with respect to the phase θ of the rotating magnetic field, the phase θ of the rotating magnetic field can be detected by the first magnetic sensor 150 in a range included in a usable region 1 and a usable region 2 illustrated in FIG. 6. That is, the range of a linear or substantially linear inclined portion other than an apex portion curved in the sine curve is the usable region of the first magnetic sensor 150.

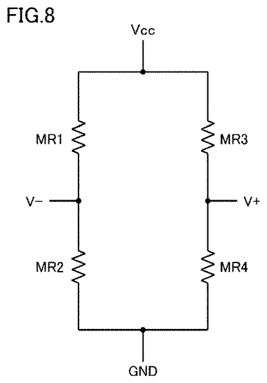

FIG. 7 is a diagram illustrating a configuration of the first magnetic sensor of the lens driving device according to Preferred Embodiment 1 of the present invention. FIG. 8 is a diagram illustrating a circuit configuration of the first magnetic sensor of the lens driving device according to Preferred Embodiment 1 of the present invention. In FIG. 7, the first magnetic sensor is illustrated in the same direction as FIG. 5.

As illustrated in FIG. 7 and FIG. 8, the first magnetic sensor 150 includes a plurality of magnetoresistive elements defining a bridge circuit. In Preferred Embodiment 1 of the present invention, the first magnetic sensor 150 includes a first magnetoresistive element MR1, a second magnetoresistive element MR2, a third magnetoresistive element MR3, and a fourth magnetoresistive element MR4.

To be specific, as illustrated in FIG. 7, in the first magnetic sensor 150, each of the first magnetoresistive element MR1, the second magnetoresistive element MR2, the third magnetoresistive element MR3, and the fourth magnetoresistive element MR4 is provided on an upper surface of the sensor substrate 151. A power supply terminal Vcc, a ground terminal GND, a first output terminal V−, and a second output terminal V+ are provided on a sensor substrate 151.

The first magnetoresistive element MR1, the second magnetoresistive element MR2, the third magnetoresistive element MR3, and the fourth magnetoresistive element MR4 are electrically connected to each other to define a Wheatstone bridge circuit. Note that the first magnetic sensor 150 may include a half bridge circuit including the first magnetoresistive element MR1 and the second magnetoresistive element MR2.

A series connection body of the first magnetoresistive element MR1 and the second magnetoresistive element MR2 and a series connection body of the third magnetoresistive element MR3 and the fourth magnetoresistive element MR4 are connected in parallel between the power supply terminal Vcc and the ground terminal GND. The first output terminal V− is connected to a connection point between the first magnetoresistive element MR1 and the second magnetoresistive element MR2. The second output terminal V+ is connected to a connection point between the third magnetoresistive element MR3 and the fourth magnetoresistive element MR4.

Each of the first magnetoresistive element MR1, the second magnetoresistive element MR2, the third magnetoresistive element MR3, and the fourth magnetoresistive element MR4 is, for example, a tunnel magnetoresistance (TMR) element.

Each of the first magnetoresistive element MR1, the second magnetoresistive element MR2, the third magnetoresistive element MR3, and the fourth magnetoresistive element MR4 has a rectangular or substantially rectangular outer shape. The first magnetoresistive element MR1, the second magnetoresistive element MR2, the third magnetoresistive element MR3, and the fourth magnetoresistive element MR4 have a square or substantially square shape as a whole. The center 150c of the first magnetic sensor 150 is located at the center of the square.

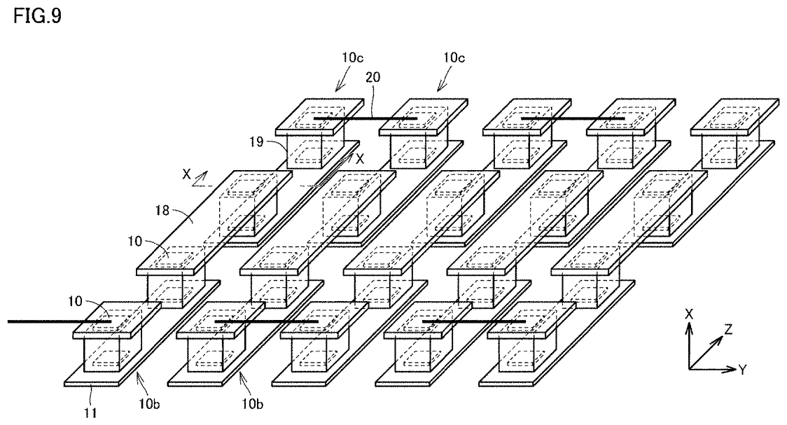

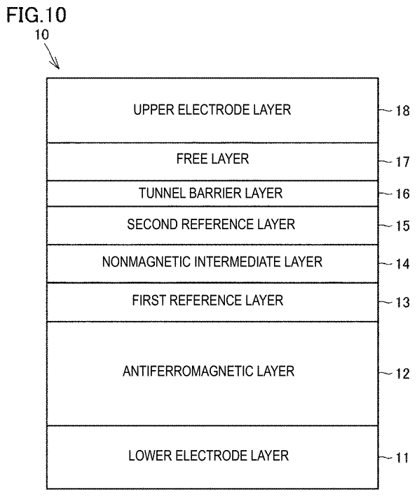

FIG. 9 is an enlarged perspective view illustrating a portion IX of FIG. 7. FIG. 10 is a cross-sectional view taken along a line X-X of FIG. 9. As illustrated in FIG. 9, each of the first magnetoresistive element MR1, the second magnetoresistive element MR2, the third magnetoresistive element MR3, and the fourth magnetoresistive element MR4 is configured by connecting a plurality of TMR elements 10 in series. The plurality of TMR elements 10 are positioned to define a matrix.

To be specific, a multilayer element 10b includes the plurality of TMR elements 10 laminated in the X-axis direction and connected in series to each other. An element array 10c includes a plurality of the multilayer elements 10b arranged in the Z-axis direction and connected in series to each other. A plurality of the element arrays 10c arranged in the Y-axis direction is alternately connected by leads 20 on one side and the other side in the Z-axis direction. Thus, the plurality of TMR elements 10 are electrically connected in series in each of the first magnetoresistive element MR1, the second magnetoresistive element MR2, the third magnetoresistive element MR3, and the fourth magnetoresistive element MR4.

As illustrated in FIG. 9, in the multilayer element 10b, an upper electrode layer 18 of the TMR element 10 located on the lower side and a lower electrode layer 11 of the TMR element 10 located on the upper side are integrally provided as an intermediate electrode layer 19. That is, the upper electrode layer 18 and the lower electrode layer 11 of the TMR element 10, which are adjacent to each other in the multilayer element 10b, are integrally provided as the intermediate electrode layer 19.

As illustrated in FIG. 10, each of the TMR elements 10 of the first magnetoresistive element MR1, the second magnetoresistive element MR2, the third magnetoresistive element MR3, and the fourth magnetoresistive element MR4 has a stacked structure including the lower electrode layer 11, an antiferromagnetic layer 12, a first reference layer 13, a nonmagnetic intermediate layer 14, a second reference layer 15, a tunnel barrier layer 16, a free layer 17, and the upper electrode layer 18.

The lower electrode layer 11 includes, for example, a metal layer or a metal compound layer including Ta and Cu. The antiferromagnetic layer 12 is provided on the lower electrode layer 11 and includes, for example, a metal compound layer such as IrMn, PtMn, FeMn, NiMn, RuRhMn, or CrPtMn. The first reference layer 13 is provided on the antiferromagnetic layer 12 and includes a ferromagnetic layer such as CoFe, for example.

The nonmagnetic intermediate layer 14 is provided on the first reference layer 13 and includes, for example, a layer selected from at least one of Ru, Cr, Rh, Ir, and Re, or an alloy including two or more of these metals. The second reference layer is provided on the nonmagnetic intermediate layer 14 and includes, for example, a ferromagnetic layer such as CoFe or CoFeB.

The tunnel barrier layer 16 is provided on the second reference layer 15 and includes a layer made of, for example, an oxide including at least one or two or more of Mg, Al, Ti, Zn, Hf, Ge, and Si, such as magnesium oxide. The free layer 17 is provided on the tunnel barrier layer 16 and includes, for example, a layer made of CoFeB or an alloy of at least one or two or more of Co, Fe, and Ni. The upper electrode layer 18 is provided on the free layer 17 and includes, for example, a metal layer such as Ta, Ru, or Cu.

The magnetization direction of pinned layers of each of the first magnetoresistive element MR1 and the fourth magnetoresistive element MR4 and the magnetization direction of pinned layers of each of the second magnetoresistive element MR2 and the third magnetoresistive element MR3 are opposite to each other by about 180°.

Note that each of the first magnetoresistive element MR1, the second magnetoresistive element MR2, the third magnetoresistive element MR3, and the fourth magnetoresistive element MR4 may include a magnetoresistive element such as, for example, a giant magnetoresistance (GMR) element or an anisotropic magnetoresistance (AMR) element, or a Hall element, instead of the TMR element.

In a case where each of the first magnetoresistive element MR1, the second magnetoresistive element MR2, the third magnetoresistive element MR3, and the fourth magnetoresistive element MR4 is a GMR element or an AMR element, in a magnetic layer of each of the first magnetoresistive element MR1 and the fourth magnetoresistive element MR4, a plurality of long portions extending in the Z-axis direction and a plurality of short portions extending in the Y-axis direction are connected in series, and have an easy magnetization axis extending in the Z-axis direction. Further, in a magnetic layer of each of the second magnetoresistive element MR2 and the third magnetoresistive element MR3, a plurality of long portions extending in the Y-axis direction and a plurality of short portions extending in the Z-axis direction are connected in series and have an easy magnetization axis extending in the Y-axis direction.

Each of the first magnetoresistive element MR1, the second magnetoresistive element MR2, the third magnetoresistive element MR3, and the fourth magnetoresistive element MR4 has an odd function input/output characteristics by including a barber pole electrode. To be specific, each of the first magnetoresistive element MR1, the second magnetoresistive element MR2, the third magnetoresistive element MR3, and the fourth magnetoresistive element MR4 includes a barber pole electrode, and thus is biased such that a current flows in a direction at a predetermined angle with respect to the magnetization direction of the magnetic layer.

The lens holder 120 can be moved in the optical axis direction by feedback controlling the output having linearity that is obtained from the first magnetic sensor 150 and adjusting the amount of current flowing through the drive coil 131. That is, the movable range of the lens in the optical axis direction of the lens is a relative movement range of the first magnetic sensor 150 with respect to the first position detecting magnet 140 in the optical axis direction of the lens, in which an output having linearity is obtained from the first magnetic sensor 150.

Here, an experimental example will be described in which it is verified by simulation analysis that a relative movement range of the first magnetic sensor 150 with respect to the first position detecting magnet 140 in the optical axis direction of the lens, in which an output having linearity is obtained from the first magnetic sensor 150, changes depending on the positional relationship between the first position detecting magnet 140 and the first magnetic sensor 150, the magnetization direction of the first position detecting magnet 140, and the type of the first magnetic sensor 150.

In this experimental example, four types of lens driving devices of Comparative Example and Example 1 to Example 3 of a preferred embodiment of the present invention were analyzed.

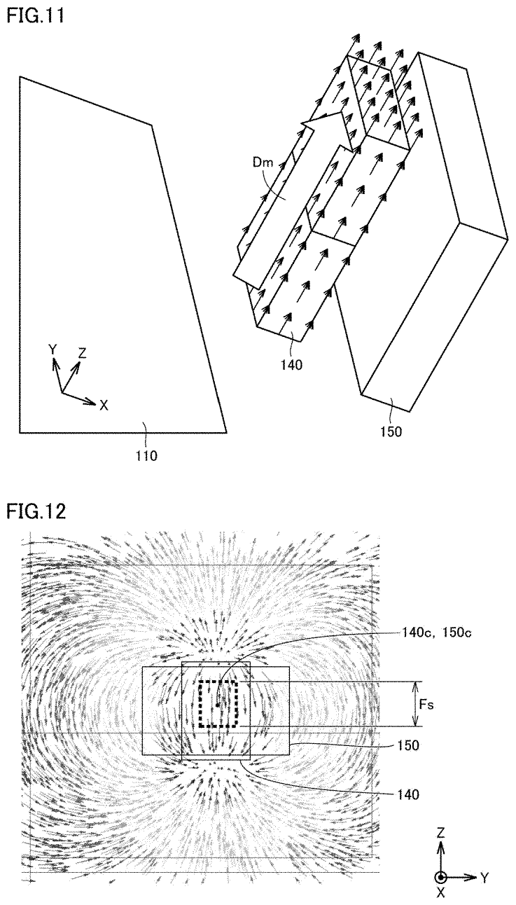

FIG. 11 is a diagram illustrating a magnetization direction of a first position detecting magnet in a lens driving device according to Comparative Example. FIG. 12 is a diagram illustrating a positional relationship between a first position detecting magnet and a first magnetic sensor, a magnetic field applied from the first position detecting magnet to the first magnetic sensor, and a relative movement range of the first magnetic sensor with respect to the first position detecting magnet in an optical axis direction of a lens, in which an output having linearity is obtained from the first magnetic sensor, in the lens driving device according to Comparative Example.

As illustrated in FIG. 11, in the lens driving device according to Comparative Example, a magnetization direction Dm of the first position detecting magnet 140 extends in the Z-axis direction and is along the optical axis direction of the lens.

In the lens driving device according to Comparative Example, a magnetic sensor that detects the intensity of magnetic field is used as the first magnetic sensor 150. Specifically, the first magnetic sensor 150 according to Comparative Example includes a Hall element capable of detecting a magnetic field in the X-axis direction.

In the lens driving device according to Comparative Example, since the first magnetic sensor 150 detects the intensity of magnetic field, the center 150c of the first magnetic sensor 150 and the center 140c of the first position detecting magnet 140 are positioned so as to overlap each other when viewed from the X-axis direction, as illustrated in FIG. 12, in order to prevent the vector of the magnetic field applied from the first position detecting magnet 140 to the first magnetic sensor 150 from rotating. That is, the center 150c of the first magnetic sensor 150 and the center 140c of the first position detecting magnet 140 are positioned so as to overlap each other in the circumferential direction of the optical axis C.

A relative movement range Fs of the first magnetic sensor 150 with respect to the first position detecting magnet 140 in the optical axis direction of the lens, in which an output having linearity is obtained from the first magnetic sensor 150, is a range surrounded by a dotted line illustrated in FIG. 12.

FIG. 13 is a graph illustrating a relationship between a relative movement range of the first magnetic sensor with respect to the first position detecting magnet in the optical axis direction of the lens and a linearity error rate of an output of the first magnetic sensor in the lens driving device according to Comparative Example. In FIG. 13, the vertical axis represents the linearity error rate (%) of the output of the first magnetic sensor, and the horizontal axis represents the relative movement range Fs (μm) of the first magnetic sensor with respect to the first position detecting magnet in the optical axis direction of the lens.

As illustrated in FIG. 13, in the lens driving device according to Comparative Example, the linearity error rate of the output of the first magnetic sensor 150 when the relative movement range Fs is about 600 μm is about 4.1%, and when the relative movement range Fs exceeds about 600 μm, the linearity error rate of the output of the first magnetic sensor 150 rapidly increases. In the lens driving device according to Comparative Example, the relative movement range Fs is approximately 610 μm at which the linearity error rate is about 4.5% as a threshold for linearity.

In the lens driving device according to Comparative Example, the relative movement range Fs is approximately 50% of a length of the first position detecting magnet 140 in the optical axis direction. In the lens driving device according to Comparative Example, in order to increase the relative movement range Fs, it is necessary to increase the length of the first position detecting magnet 140 in the optical axis direction.

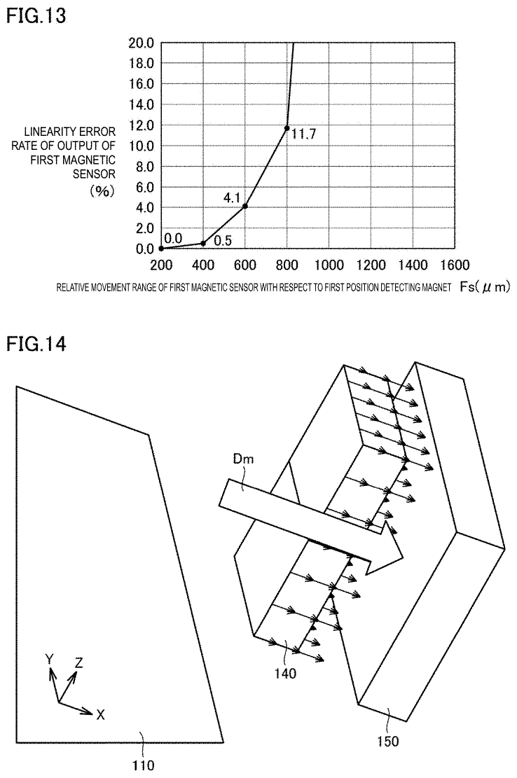

FIG. 14 is a diagram illustrating the magnetization direction of the first position detecting magnet in a lens driving device according to Example 1 of a preferred embodiment of the present invention. FIG. 15 is a diagram illustrating a positional relationship between a first position detecting magnet and a first magnetic sensor, a magnetic field applied from the first position detecting magnet to the first magnetic sensor, and a relative movement range of the first magnetic sensor with respect to the first position detecting magnet in an optical axis direction of a lens, in which an output having linearity is obtained from the first magnetic sensor, in the lens driving device according to Example 1.

FIG. 14 illustrates a state before the center 150c of the first magnetic sensor 150 is displaced with respect to the center 140c of the first position detecting magnet 140. In FIG. 15, a state before the center 150c of the first magnetic sensor 150 is displaced with respect to the center 140c of the first position detecting magnet 140 is indicated by a chain double-dashed line, and a state after the center 150c of the first magnetic sensor 150 is displaced with respect to the center 140c of the first position detecting magnet 140 is indicated by a solid line.

As illustrated in FIG. 14, in the lens driving device according to Example 1, the magnetization direction Dm of the first position detecting magnet 140 extends in the X-axis direction and is along the radial direction of the optical axis C passing through the center 140c of the first position detecting magnet 140.

In the lens driving device according to Example 1, a magnetic sensor that detects a rotating magnetic field is used as the first magnetic sensor 150. Specifically, the first magnetic sensor 150 according to Example 1 includes a magnetoresistive element the same as or similar to that of Preferred Embodiment 1.

In the lens driving device according to Example 1, since the first magnetic sensor 150 detects the rotating magnetic field, as illustrated in FIG. 15, the center 150c of the first magnetic sensor 150 and the center 140c of the first position detecting magnet 140 are positioned to be displaced from each other in the Y-axis direction when viewed from the X-axis direction. In Example 1, the center 150c of the first magnetic sensor 150 is positioned to be displaced by about 1 mm in the Y-axis direction with respect to the center 140c of the first position detecting magnet 140. That is, the center 150c of the first magnetic sensor 150 and the center 140c of the first position detecting magnet 140 are positioned to be displaced from each other in the circumferential direction of the optical axis C.

A relative movement range Fs of the first magnetic sensor 150 with respect to the first position detecting magnet 140 in the optical axis direction of the lens, in which an output having linearity is obtained from the first magnetic sensor 150, is a range surrounded by a dotted line illustrated in FIG. 15.

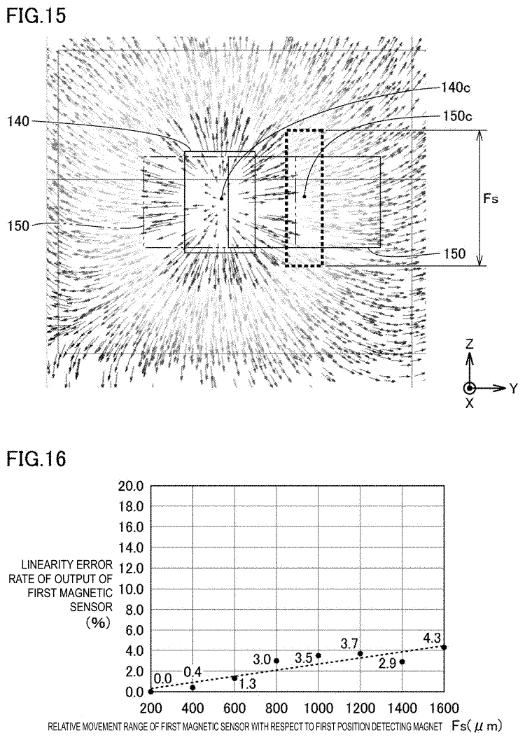

FIG. 16 is a graph illustrating a relationship between a relative movement range of the first magnetic sensor with respect to the first position detecting magnet in the optical axis direction of the lens and a linearity error rate of an output of the first magnetic sensor in the lens driving device according to Example 1. In FIG. 16, the vertical axis represents the linearity error rate (%) of the output of the first magnetic sensor, and the horizontal axis represents the relative movement range Fs (μm) of the first magnetic sensor with respect to the first position detecting magnet in the optical axis direction of the lens.

As illustrated in FIG. 16, in the lens driving device according to Example 1, the linearity error rate of the output of the first magnetic sensor 150 when the relative movement range Fs is about 1600 μm is about 4.3%, and the linearity error rate of the output of the first magnetic sensor 150 gradually increases in or substantially in proportion to the relative movement range Fs. In the lens driving device according to Example 1, the relative movement range Fs is approximately 1630 μm at which the linearity error rate becomes about 4.5% as a threshold for linearity.

In the lens driving device according to Example 1, since the first magnetic sensor 150 detects the angle of the magnetic field radially spreading from the first position detecting magnet 140 at a position displaced in the circumferential direction of the optical axis C with respect to the first position detecting magnet 140, the relative movement range Fs longer than the length of the first position detecting magnet 140 in the optical axis direction can be achieved.

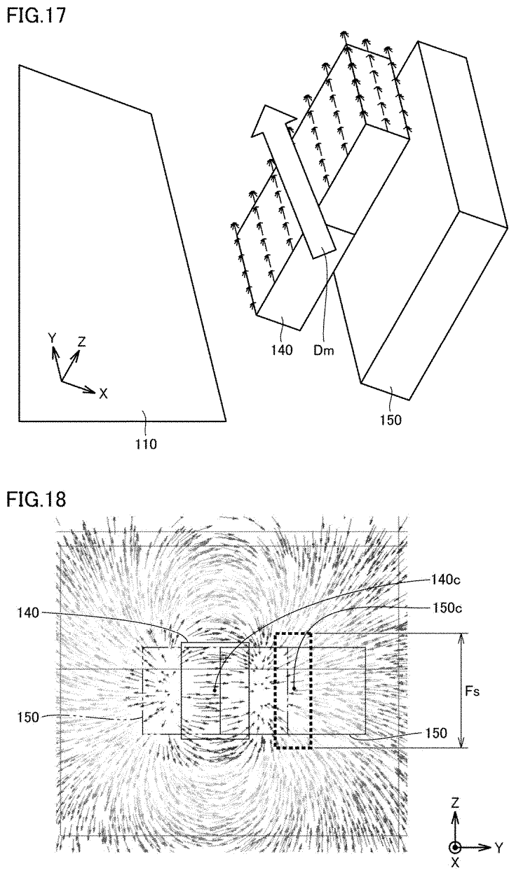

FIG. 17 is a diagram illustrating the magnetization direction of the first position detecting magnet in a lens driving device according to Example 2 of a preferred embodiment of the present invention. FIG. 18 is a diagram illustrating a positional relationship between a first position detecting magnet and a first magnetic sensor, a magnetic field applied from the first position detecting magnet to the first magnetic sensor, and a relative movement range of the first magnetic sensor with respect to the first position detecting magnet in an optical axis direction of a lens, in which an output having linearity is obtained from the first magnetic sensor, in the lens driving device according to Example 2.

FIG. 17 illustrates a state before the center 150c of the first magnetic sensor 150 is displaced with respect to the center 140c of the first position detecting magnet 140. In FIG. 18, a state before the center 150c of the first magnetic sensor 150 is displaced with respect to the center 140c of the first position detecting magnet 140 is indicated by a chain double-dashed line, and a state after the center 150c of the first magnetic sensor 150 is displaced with respect to the center 140c of the first position detecting magnet 140 is indicated by a solid line.

As illustrated in FIG. 17, in the lens driving device according to Example 2, the magnetization direction Dm of the first position detecting magnet 140 extends in the Y-axis direction and is along a direction orthogonal or substantially orthogonal to each of the radial direction of the optical axis C passing through the center 140c of the first position detecting magnet 140 and the optical axis direction of the lens.

In the lens driving device according to Example 2, a magnetic sensor that detects a rotating magnetic field is used as the first magnetic sensor 150. Specifically, the first magnetic sensor 150 according to Example 2 includes a magnetoresistive element the same as or similar to that of Preferred Embodiment 1.

In the lens driving device according to Example 2, since the first magnetic sensor 150 detects the rotating magnetic field, as illustrated in FIG. 18, the center 150c of the first magnetic sensor 150 and the center 140c of the first position detecting magnet 140 are positioned to be displaced from each other in the Y-axis direction when viewed from the X-axis direction. In Example 2, the center 150c of the first magnetic sensor 150 is positioned to be displaced by about 1 mm in the Y-axis direction with respect to the center 140c of the first position detecting magnet 140. That is, the center 150c of the first magnetic sensor 150 and the center 140c of the first position detecting magnet 140 are positioned to be displaced from each other in the circumferential direction of the optical axis C.

The relative movement range Fs in the optical axis direction of the lens of the first magnetic sensor 150 with respect to the first position detecting magnet 140, in which an output having linearity is obtained from the first magnetic sensor 150, is a range surrounded by a dotted line illustrated in FIG. 18.

In the lens driving device according to Example 2, since the first magnetic sensor 150 detects the angle of the magnetic field radially spreading from the first position detecting magnet 140 at a position displaced in the circumferential direction of the optical axis C with respect to the first position detecting magnet 140, the relative movement range Fs longer than the length of the first position detecting magnet 140 in the optical axis direction can be achieved.

As illustrated in FIG. 11, in a lens driving device according to Example 3 of a preferred embodiment of the present invention, the magnetization direction Dm of the first position detecting magnet 140 extends in the Z-axis direction and is along the optical axis direction of the lens.

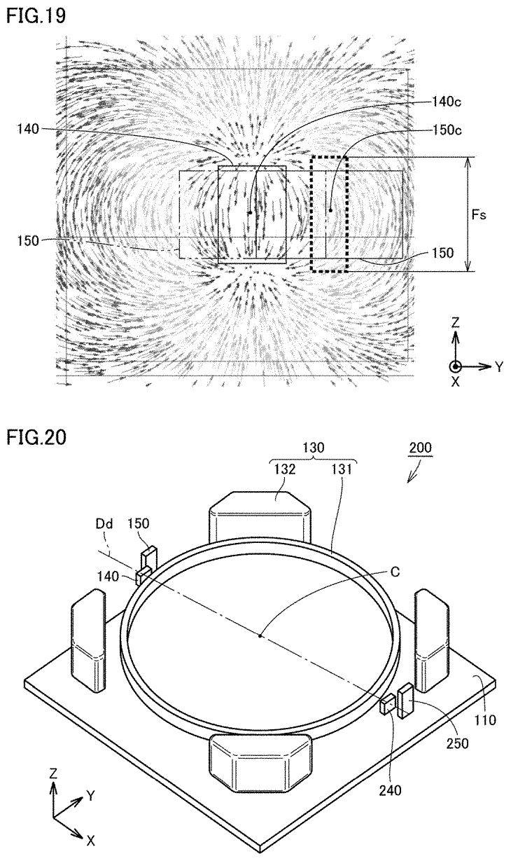

FIG. 19 is a diagram illustrating a positional relationship between a first position detecting magnet and a first magnetic sensor, a magnetic field applied from the first position detecting magnet to the first magnetic sensor, and a relative movement range of the first magnetic sensor with respect to the first position detecting magnet in an optical axis direction of a lens, in which an output having linearity is obtained from the first magnetic sensor, in the lens driving device according to Example 3.

In FIG. 19, a state before the center 150c of the first magnetic sensor 150 is displaced with respect to the center 140c of the first position detecting magnet 140 is indicated by a chain double-dashed line, and a state after the center 150c of the first magnetic sensor 150 is displaced with respect to the center 140c of the first position detecting magnet 140 is indicated by a solid line.

In the lens driving device according to Example 3, a magnetic sensor that detects a rotating magnetic field is used as the first magnetic sensor 150. Specifically, the first magnetic sensor 150 according to Example 3 includes a magnetoresistive element the same as or similar to that of Preferred Embodiment 1.

In the lens driving device according to Example 3, since the first magnetic sensor 150 detects the rotating magnetic field, as illustrated in FIG. 19, the center 150c of the first magnetic sensor 150 and the center 140c of the first position detecting magnet 140 are positioned to be displaced from each other in the Y-axis direction when viewed from the X-axis direction. In Example 3, the center 150c of the first magnetic sensor 150 is positioned to be displaced by about 1 mm in the Y-axis direction with respect to the center 140c of the first position detecting magnet 140. That is, the center 150c of the first magnetic sensor 150 and the center 140c of the first position detecting magnet 140 are positioned to be displaced from each other in the circumferential direction of the optical axis C.

The relative movement range Fs of the first magnetic sensor 150 with respect to the first position detecting magnet 140 in the optical axis direction of the lens, in which an output having linearity is obtained from the first magnetic sensor 150, is a range surrounded by a dotted line illustrated in FIG. 19.

In the lens driving device according to Example 3, since the first magnetic sensor 150 detects the angle of the magnetic field radially spreading from the first position detecting magnet 140 at a position displaced in the circumferential direction of the optical axis C with respect to the first position detecting magnet 140, the relative movement range Fs longer than the length of the first position detecting magnet 140 in the optical axis direction can be ensured.

Note that among Example 1 to Example 3, the lens driving device according to Example 1 has the smallest variation in the angle of the magnetic field applied to the first magnetic sensor 150 when the relative position between the first position detecting magnet 140 and the first magnetic sensor 150 changes in the optical axis direction of the lens, and thus has the largest relative movement range Fs.

According to the experimental example described above, it was confirmed that the relative movement range Fs of the first magnetic sensor 150 with respect to the first position detecting magnet 140 in the optical axis direction of the lens, in which an output having linearity is obtained from the first magnetic sensor 150, changes depending on the positional relationship between the first position detecting magnet 140 and the first magnetic sensor 150, the magnetization direction of the first position detecting magnet 140, and the type of the first magnetic sensor 150.

In the lens driving device according to Preferred Embodiment 1 of the present invention, the first magnetic sensor 150 can detect a rotating magnetic field applied from the first position detecting magnet 140 that moves relatively when the lens holder 120 moves in the optical axis direction of the lens, and the center 150c of the first magnetic sensor 150 and the center 140c of the first position detecting magnet 140 are positioned to be displaced from each other in the circumferential direction of the optical axis C when viewed from the optical axis direction of the lens. Accordingly, in the lens driving device 100, the relative movement range Fs can be increased without increasing the size of the first position detecting magnet 140, and thus the movable range of the lens can be increased.

In the lens driving device according to Preferred Embodiment 1 of the present invention, the center 150c of the first magnetic sensor 150 does not overlap the first position detecting magnet 140 in the circumferential direction of the optical axis C when viewed from the optical axis direction of the lens. Accordingly, compared to a case where the center 150c of the first magnetic sensor 150 overlaps the first position detecting magnet 140 in the circumferential direction of the optical axis C, the relative movement range Fs can be further increased, and thus the movable range of the lens can be further increased.

In the lens driving device according to Preferred Embodiment 1 of the present invention, the first magnetic sensor 150 does not overlap the first position detecting magnet 140 in the circumferential direction of the optical axis C when viewed from the optical axis direction of the lens. Accordingly, compared to a case where the first magnetic sensor 150 overlaps the first position detecting magnet 140 in the circumferential direction of the optical axis C, the relative movement range Fs can be further increased, and thus the movable range of the lens can be further increased.

In the lens driving device according to Preferred Embodiment 1 of the present invention, the magnetization direction of the first position detecting magnet 140 is along the radial direction Dd of the optical axis C passing through the center 140c of the first position detecting magnet 140. This makes it possible to reduce variation in the angle of the magnetic field applied to the first magnetic sensor 150 when the relative position between the first position detecting magnet 140 and the first magnetic sensor 150 changes in the optical axis direction of the lens, thereby making it possible to increase the relative movement range Fs and thus to increase the movable range of the lens.

In the lens driving device according to Preferred Embodiment 1 of the present invention, the first magnetic sensor 150 includes a plurality of magnetoresistive elements defining a bridge circuit. Thus, the rotating magnetic field can be easily detected by the first magnetic sensor 150.

In the lens driving device according to Preferred Embodiment 1 of the present invention, the driver 130 includes the drive coil 131 and the drive magnet 132. The drive coil 131 is wound around the lens holder 120. The drive magnet 132 faces the outer peripheral side of the drive coil 131 with a gap therebetween. Thus, a voice coil motor is provided, and the lens holder 120 can be driven in the optical axis direction.

### Preferred Embodiment 2

Hereinafter, a lens driving device according to Preferred Embodiment 2 of the present invention will be described with reference to the drawings. The lens driving device according to Preferred Embodiment 2 of the present invention differs from the lens driving device 100 according to Preferred Embodiment 1 of the present invention mainly in that the lens driving device according to Preferred Embodiment 2 of the present invention further includes a second position detecting magnet and a second magnetic sensor, and therefore description of configurations the same as or similar to those of the lens driving device 100 according to Preferred Embodiment 1 of the present invention will not be repeated.

FIG. 20 is a perspective view illustrating a positional relationship among a first position detecting magnet, a first magnetic sensor, a second position detecting magnet, and a second magnetic sensor in the lens driving device according to Preferred Embodiment 2 of the present invention. FIG. 20 is illustrated as viewed from the same direction as FIG. 3. In FIG. 20, the lens holder is not illustrated.

As illustrated in FIG. 20, a lens driving device 200 according to Preferred Embodiment 2 of the present invention further includes a second position detecting magnet 240 and a second magnetic sensor 250. The second position detecting magnet 240 is located on the outer peripheral side of the lens holder 120. In Preferred Embodiment 2 of the present invention, the second position detecting magnet 240 has a rectangular or substantially rectangular parallelepiped shape. The second position detecting magnet 240 moves in the optical axis direction of the lens together with the lens holder 120.

In Preferred Embodiment 2 of the present invention, the magnetization direction of the second position detecting magnet 240 is along the radial direction Dd of the optical axis C passing through the center 140c of the first position detecting magnet 140. The second position detecting magnet 240 has the same or substantially the same configuration as that of the first position detecting magnet 140.

The second magnetic sensor 250 is located at a distance from the second position detecting magnet 240 in the radial direction of the optical axis C. When viewed from the optical axis direction of the lens, the center of the second magnetic sensor 250 and the center of the second position detecting magnet 240 are displaced from each other in the circumferential direction of the optical axis C. The second magnetic sensor 250 has the same or substantially the same configuration as that of the first magnetic sensor 150.

The second position detecting magnet 240 and the second magnetic sensor 250 are located on a side opposite to each other in the radial direction of the optical axis C with respect to the first position detecting magnet 140 and the first magnetic sensor 150.

The second magnetic sensor 250 can detect a rotating magnetic field applied from the second position detecting magnet 240 that moves relatively when the lens holder 120 moves in the optical axis direction of the lens.

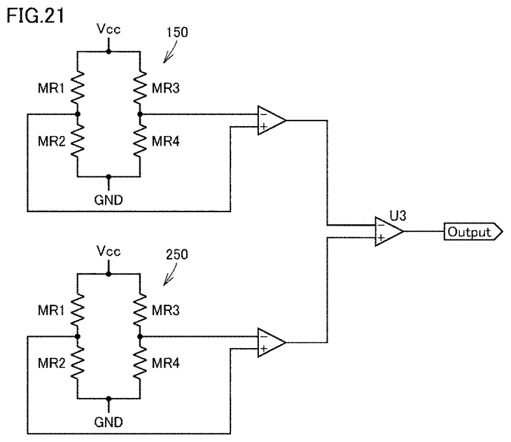

FIG. 21 is a diagram illustrating a circuit configuration of the first magnetic sensor and the second magnetic sensor of the lens driving device according to Preferred Embodiment 2 of the present invention. As illustrated in FIG. 21, a detection value of the first magnetic sensor 150 and a detection value of the second magnetic sensor 250 are differentially amplified and output. Thus, the inclination of the lens holder 120 can be detected. The inclination of the lens holder 120 can be reduced by feedback controlling the detected inclination of the lens holder 120 and adjusting the distribution of the amount of current flowing through the drive coil 131.

### Preferred Embodiment 3

Hereinafter, a lens driving device according to Preferred Embodiment 3 of the present invention will be described with reference to the drawings. The lens driving device according to Preferred Embodiment 3 of the present invention differs from the lens driving device 200 according to Preferred Embodiment 2 of the present invention mainly in the configuration of the driver, and therefore description of configurations the same as or similar to those of the lens driving device 200 according to Preferred Embodiment 2 of the present invention will not be repeated.

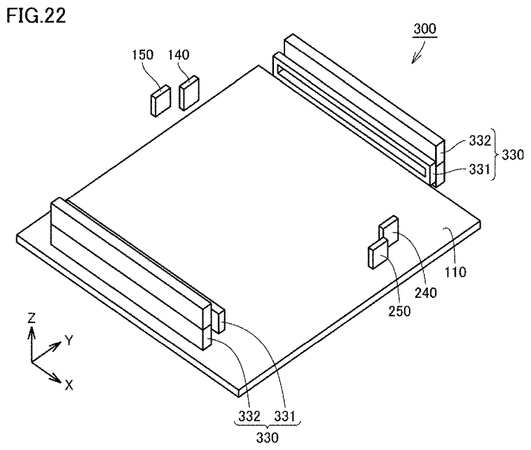

FIG. 22 is a perspective view illustrating a positional relationship among a first position detecting magnet, a first magnetic sensor, a second position detecting magnet, and a second magnetic sensor in the lens driving device according to Preferred Embodiment 3 of the present invention. FIG. 22 is illustrated as viewed from the same direction as FIG. 3. In FIG. 22, the lens holder is not illustrated.

As illustrated in FIG. 22, in a lens driving device 300 according to Preferred Embodiment 3 of the present invention, a driver 330 includes a pair of drive coils 331 and a pair of drive magnets 332. The driver 330 includes a voice coil motor.

The pair of drive coils 331 are attached to both sides of the lens holder 120 in the Y-axis direction. The pair of drive magnets 332 face the pair of drive coils 331 in a one-to-one correspondence. In Preferred Embodiment 3 of the present invention, two drive magnets 332 face the outer peripheral surface of the lens holder 120.

The driver 330 can also move the lens holder 120 in the optical axis direction of the lens.

In the above description of the preferred embodiments, configurations that can be combined may be combined with each other.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A lens driving device comprising:
a lens holder including a cavity and holding a lens;
a driver to move the lens holder in an optical axis direction of the lens passing through a center of the cavity;
a first position detecting magnet; and
a first magnetic sensor capable of detecting a magnetic field applied from the first position detecting magnet that moves relatively when the lens holder moves in the optical axis direction; wherein
one of the first position detecting magnet and the first magnetic sensor is located on an outer peripheral side of the lens holder;
another one of the first position detecting magnet and the first magnetic sensor is located at a distance from the one of the first position detecting magnet and the first magnetic sensor in a radial direction of an optical axis of the lens; and
a center of the first magnetic sensor and a center of the first position detecting magnet are displaced from each other in a circumferential direction of the optical axis when viewed from the optical axis direction.

2. The lens driving device according to claim 1, wherein the center of the first magnetic sensor does not overlap the first position detecting magnet in the circumferential direction of the optical axis when viewed from the optical axis direction.

3. The lens driving device according to claim 2, wherein the first magnetic sensor does not overlap the first position detecting magnet in the circumferential direction of the optical axis when viewed from the optical axis direction.

4. The lens driving device according to claim 1, wherein a magnetization direction of the first position detecting magnet is along the radial direction of the optical axis passing through the center of the first position detecting magnet.

5. The lens driving device according to claim 1, wherein the first magnetic sensor includes a plurality of magnetoresistive elements defining a bridge circuit.

6. The lens driving device according to claim 1, wherein
the driver includes:
at least one drive coil wound around the lens holder; and
at least one drive magnet facing an outer peripheral side of the drive coil with a gap therebetween.

7. The lens driving device according to claim 1, further comprising:
a second position detecting magnet; and
a second magnetic sensor capable of detecting a magnetic field applied from the second position detecting magnet that moves relatively when the lens holder moves in the optical axis direction; wherein
one of the second position detecting magnet and the second magnetic sensor is located on the outer peripheral side of the lens holder;
another one of the second position detecting magnet and the second magnetic sensor is located at a distance from the one of the second position detecting magnet and the second magnetic sensor in the radial direction of the optical axis of the lens;
a center of the second magnetic sensor and a center of the second position detecting magnet are displaced from each other in the circumferential direction of the optical axis when viewed from the optical axis direction; and
the second position detecting magnet and the second magnetic sensor are located on sides opposite to each other in the radial direction of the optical axis with respect to the first position detecting magnet and the first magnetic sensor.

8. The lens driving device according to claim 1, wherein the cavity is circular or substantially circular.

9. The lens driving device according to claim 1, wherein an outer peripheral surface of the lens holder has an octagonal or substantially octagonal shape.

10. The lens driving device according to claim 6, wherein the at least one drive magnet includes four drive magnets facing the outer peripheral side of the drive coil.

11. The lens driving device according to claim 10, wherein the four drive magnets are provided at equal or substantially equal intervals in the circumferential direction.

12. The lens driving device according to claim 1, wherein the first position detecting magnet has a rectangular or substantially rectangular parallelepiped shape.

13. The lens driving device according to claim 7, wherein the second position detecting magnet has a rectangular or substantially rectangular parallelepiped shape.

14. The lens driving device according to claim 7, wherein the first position detecting magnet and the second position detecting magnet are located on opposite sides in the radial direction of the optical axis of the lens.

15. The lens driving device according to claim 6, wherein the at least one drive coil includes a pair of drive coils and the at least one drive magnet include a pair of drive magnets.

16. The lens driving device according to claim 15, wherein the pair of drive magnetic face the pair of drive coils in a one-to-one correspondence.
